(19) United States
(12) Patent Application Publication
(10) Pub. No.: US 2013/0328921 A1
(43) Pub. Date: Dec. 12, 2013

(54) Utilizing Heat Maps to Represent Respondent Sentiments

(71) Applicant: Palanivel Kuppusamy, (US)

(72) Inventor: Palanivel Kuppusamy, (US)

(73) Assignee: iPinion, Inc.

(21) Appl. No.: 13/492,147

(22) Filed: Jun. 8, 2012

(51) Int. Cl. G09G 5/00

(52) U.S. Cl. 345/629

(57) ABSTRACT

An apparatus utilizes heat maps to represent respondent sentiments. A datastore has recorded therein respondent feedback corresponding to detected interaction by respondents, during first and second modes of operation, with a touch screen displaying a test image. The respondent feedback is recorded in the datastore by feedback types according to the first and second modes of operation. A feedback compilation engine compiles the respondent feedback according to the feedback types. A heat map rendering engine graphically renders the respondent feedback as a feedback type specific heat map overlaying the test image.

### CROSS-REFERENCE TO RELATED APPLICATIONS

This patent application is related to commonly assigned, co-pending U.S. patent application Ser. No. ______, filed Jun. 8, 2012 and entitled Compiling Images Within a Respondent Interface Using Layers and Highlight Features (Attorney Docket: ERWP.P0008US), the disclosure of which is incorporated by reference herein in its entirety.

### TECHNICAL FIELD

This disclosure is generally directed to a system and method for representing survey results. This disclosure is specifically directed to a system and method for utilizing heat maps to represent respondent sentiments.

### BACKGROUND

Market research is an organized effort to gather information about markets or customers. Market research can include social and opinion research performed to systematically gather and interpret information about individuals or organizations using statistical and analytical methods and techniques of the applied social sciences to gain insight or support decision making. Viewed as an important component of business strategy, market research can be a key factor to obtain advantage over competitors. Market research provides important information to identify and analyze market need, market size, and competition.

The advent of mobile devices, such as smart phones, presents new opportunities for enlisting mobile device users as respondents in performing market research. However, the limited touch screen interfaces of such mobile devices present new challenges for interfacing with respondents in performing market research surveys. Accordingly, new challenges have arisen regarding meaningfully representing results of such research.

### BRIEF SUMMARY

In some aspects, an apparatus utilizes heat maps to represent respondent sentiments. A datastore has recorded therein respondent feedback corresponding to detected interaction by respondents, during first and second modes of operation, with a touch screen displaying a test image. The respondent feedback is recorded in the datastore by feedback types according to the first and second modes of operation. A feedback compilation engine compiles the respondent feedback according to the feedback types. A heat map rendering engine graphically renders the respondent feedback as a feedback type specific heat map overlaying the test image.

In other aspects, a method of utilizing heat maps to represent respondent sentiments includes accessing, by a computer processor, a datastore. The datastore has recorded therein respondent feedback corresponding to detected interaction by respondents, during first and second modes of operation, with a touch screen displaying a test image. The respondent feedback is recorded in the datastore by feedback types according to the first and second modes of operation. The respondent feedback is compiled according to the feedback types, and graphically rendered as a feedback type specific heat map overlaying the test image.

In further aspects, a computer program product for utilizing heat maps to represent respondent sentiments, includes a non-transitory computer-readable medium having program code recorded thereon. The program code includes program code to access, by a computer processor, a datastore recording respondent feedback corresponding to detected interaction by respondents, during first and second modes of operation, with a touch screen displaying a test image. The respondent feedback is recorded in the datastore by feedback types according to the first and second modes of operation. The program code includes program code to compile the respondent feedback according to the feedback types, and program code to graphically render the respondent feedback as a feedback type specific heat map overlaying the test image.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE FIGURES

For a more complete understanding of the present invention, reference is now made to the following descriptions taken in conjunction with the accompanying FIGURES, in which:

FIG. 1 is a graphical representation of a user interface generating a display of a heat map in accordance with the present disclosure;

FIG. 2 is another graphical representation of a user interface generating a display of a heat map in accordance with the present disclosure;

FIG. 3 is a block diagram illustrating heat map generation in accordance with the present disclosure;

FIG. 4 is a block diagram illustrating respondent feedback compilation in accordance with the present disclosure;

FIG. 5 is a block diagram illustrating further respondent feedback compilation in accordance with the present disclosure; and

FIG. 6 is a flow diagram illustrating heat map generation in accordance with the present disclosure.

### DETAILED DESCRIPTION

By way of overview, techniques and methods are disclosed for utilizing heat maps to represent respondent sentiments. Use of heat maps to overlay a test image effectively communicates results of touch screen interaction of respondents while viewing a test image during two or more modes of operation. For example, users may highlight regions of the test image with different hues of highlight to indicate preference, and this feedback can be communicated using separate heat maps for each hue of highlight. The respondent interface having the two modes of operation may provide a display of the test image with respondent selectable controls for initiating the first and second modes of operation. The respondent interface may also detect the respondent interaction with the touch screen displaying the test image during the first and second modes of operation, and record results of the respondent interaction in the datastore by feedback type according to the first and second modes of operation. The heat map utilization may occur in the back end, for example, in a customer interface. Additional details regarding respondent highlight layer definition are described in a related, commonly assigned, co-pending U.S. patent application Ser. No. ______, filed Jun. 8, 2012 and entitled Compiling Images Within a Respondent Interface Using Layers and Highlight Features, the disclosure of which is incorporated by reference herein in its entirety.

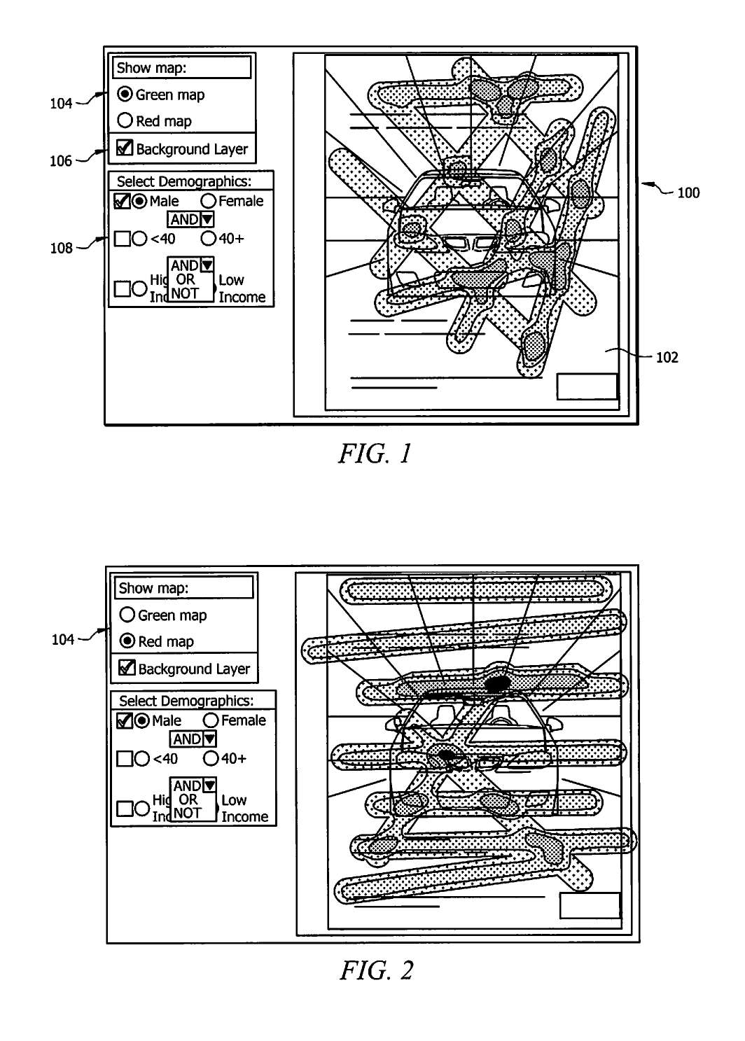

FIG. 1 illustrates a user interface generating a display of a heat map 100 in accordance with the present disclosure. The heat map 100 may be rendered as a layer that overlays a test image 102 that was shown to the respondents during first and second modes of operation in which the respondents used different hues of highlight to markup the test image. Controls of the user interface may include a feedback type selection control 104 that allows the user to select which type of feedback should be included in the heat map 100. In some embodiments, a background layer filter control 106 may be provided to permit the user to make a selection to view the heat map 100 without the test image 102 layer being displayed. In other embodiments, control 106 may be absent, and the test image 102 is automatically rendered underneath the heat map 100. In additional embodiments, demographics filter control 108 may be provided for the user to select which feedback should be included in the heat map 100 according to respondent demographics. In some embodiments, Boolean operators may be supported to filter the feedback by demographics. It should be understood that the controls 104, 106, and 108 may be provided in a number of different ways that will be readily apparent to one skilled in the art, such as tabs that provide screens of controls separately from display of the heat map 100.

FIG. 2 illustrates the user interface generating a display of another heat map 200 in accordance with the present disclosure. The heat map 200 is generated from feedback of a different type, and is therefore feedback type specific. The user may employ control 104 to determine which of the heat maps is displayed. In additional or alternative embodiments, the control 104 may be absent, and two or more heat maps, one for each type of feedback, may be simultaneously displayed to the user (e.g., side by side) for comparison. Alternatively or additionally, a prompt that was presented to the respondent for initiating the respondent interaction may also be displayed.

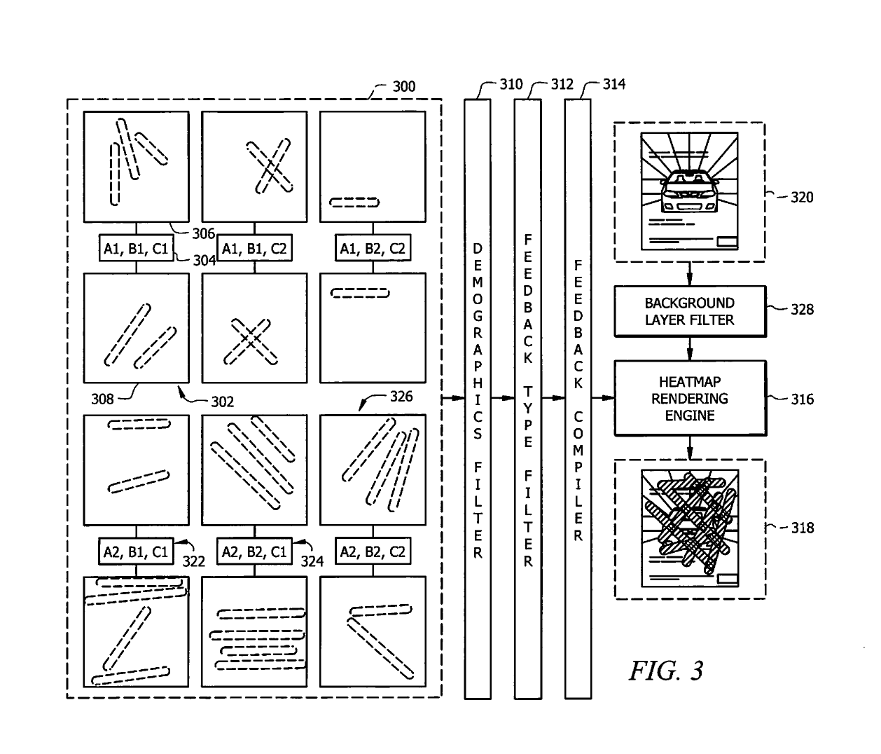

FIG. 3 illustrates an apparatus utilizing heat maps to represent respondent sentiments. A datastore 300 may record respondent feedback corresponding to detected interaction by respondents, during first and second modes of operation, with a touch screen displaying a test image. The respondent feedback may be recorded in the datastore by feedback types according to the first and second modes of operation. For example, a data object 302 may be specific to a test image and may represent a particular respondent's demographics 304, feedback 306 of the respondent during the first mode of operation, and feedback 308 of the respondent during the second mode of operation. In some embodiments, the feedback 304 and 306 may be recorded in the datastore as highlight pixel data resulting from the respondent interaction. In other embodiments, the respondent feedback may be recorded in the datastore as respondent interaction objects that resulted in highlight of the test image during the first and second modes of operation.

In some embodiments, a demographics filtering engine 310 may receive user selections regarding the respondent demographics, and filter the respondent feedback according to the user selections. A feedback type filtering engine 312 may also receive user selections regarding feedback type, and filter the respondent feedback according to the user selections. A feedback compilation engine 314 may compile the respondent feedback according to the feedback types. In some embodiments, this compilation may generate a matrix of colors, while other embodiments may assemble a collection or set of binary bit maps or data objects to be used in generating a matrix of colors. A heat map rendering engine 316 may graphically render the respondent feedback as a feedback type specific heat map 318 overlaying the test image 320. In some embodiments, the rendering engine 316 may receive a matrix of colors from compilation engine 314. In other embodiments, heat map rendering engine 316 may generate a matrix of colors from a collection or set of binary bit maps or data objects. Feedback type filtering engine 312 may respond to user control to result in compiling respondent feedback of the feedback type selected by the user, and rendering of a heat map 318 specific to the feedback type selected by the user. Demographics filtering engine 310 may respond to user control to result in compiling respondent feedback of the respondent demographics selected by the user, and graphically rendering a respondent demographic specific heat map. For example, if a user has selected to view positive feedback of respondents having a demographic shared by respondents represented by data objects 322, 324, and 326, then only the feedback of the first type associated with each object 322, 324, and 326 may pass through filtering engines 310 and 312 for compilation by feedback compilation engine 314 and display by rendering engine 316 as heat map 318. In some embodiments, a background layer filtering engine 328 receives user selections regarding whether to display the test image 320, allowing rendering engine 316 to graphically render the respondent feedback as a feedback type specific heat map 318 without the test image 320 if desired. In some embodiments, heat map rendering engine 316 graphically renders, together with the heat map 318, a prompt that was presented to the respondent for initiating the respondent interaction.

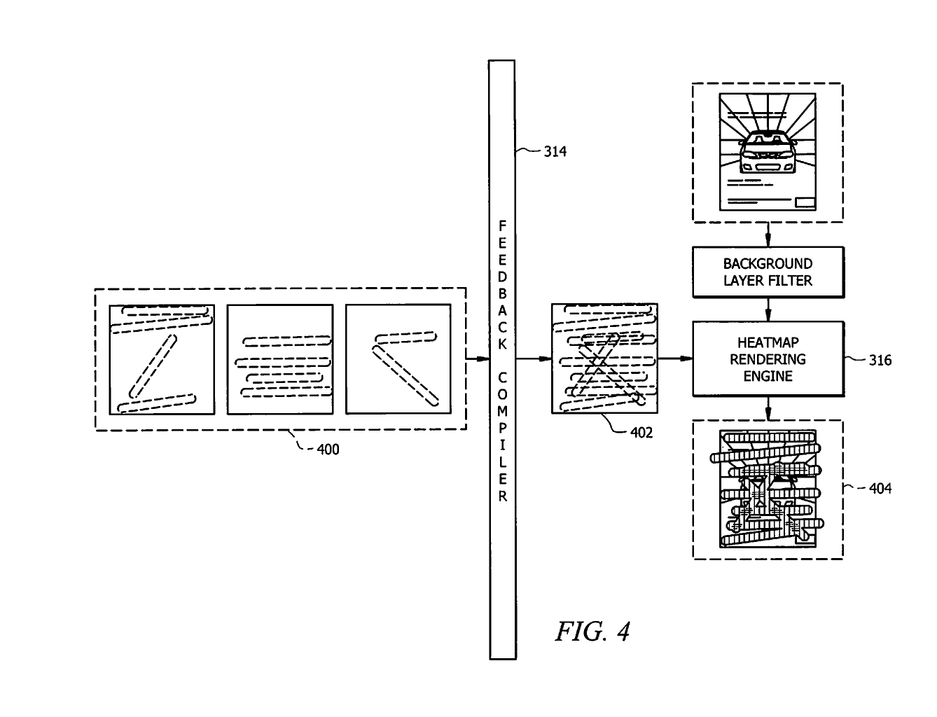

FIG. 4 illustrates respondent feedback compilation for the negative feedback 400 of the respondents having the user-selected demographics. The negative feedback 400 is retrieved by feedback compilation engine 314 employing any of the aforementioned filters. In some embodiments, the feedback may be compiled into a collection 402 of sets pixels or objects for generating a matrix of colors to be used in a heat map layer as previously described. The resulting collection 402 may be used by rendering engine 316 to generate heat map 404 communicating the negative feedback of the respondents having the selected demographics.

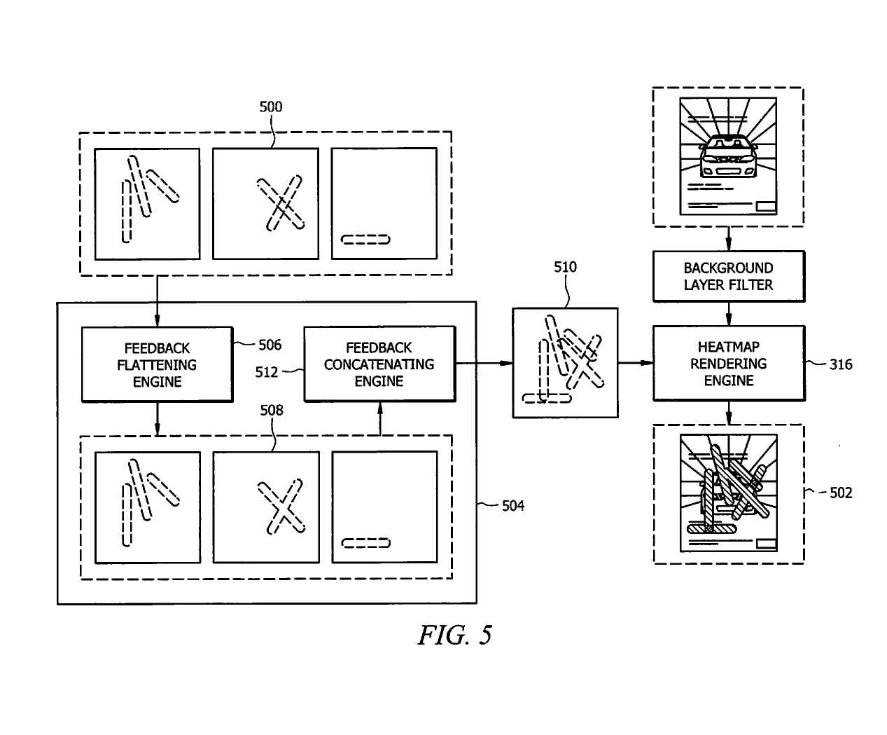

FIG. 5 illustrates respondent feedback compilation for feedback stored as overlapping screen swipe data objects. In order to prevent overlapping screen interactions 500 of a single user from resulting in misleading hot spots in the heat map 502, feedback compilation engine 504 may have a feedback flattening engine 506 that flattens the overlapping interaction 500 into a single, non-overlapping data object 508, or converts all of the interactions into pixels of equal value (i.e., without any hot spots). In other words, recorded touch screen motion vectors may be used to generate binary bitmaps in the same or similar way that a highlight layer is generated, as will be well understood by one skilled in the art. The results may further be compiled into a collection 510 as a matrix of colors by feedback concatenating engine 512 and provided to heat map rendering engine 316. However, similar results may be achieved in other embodiments by flattening of the results of each user in the respondent interface, such that all of the feedback in the datastore is already flattened. In other words, the binary bit maps of highlight data may be stored as the feedback, rather than the original motion vectors.

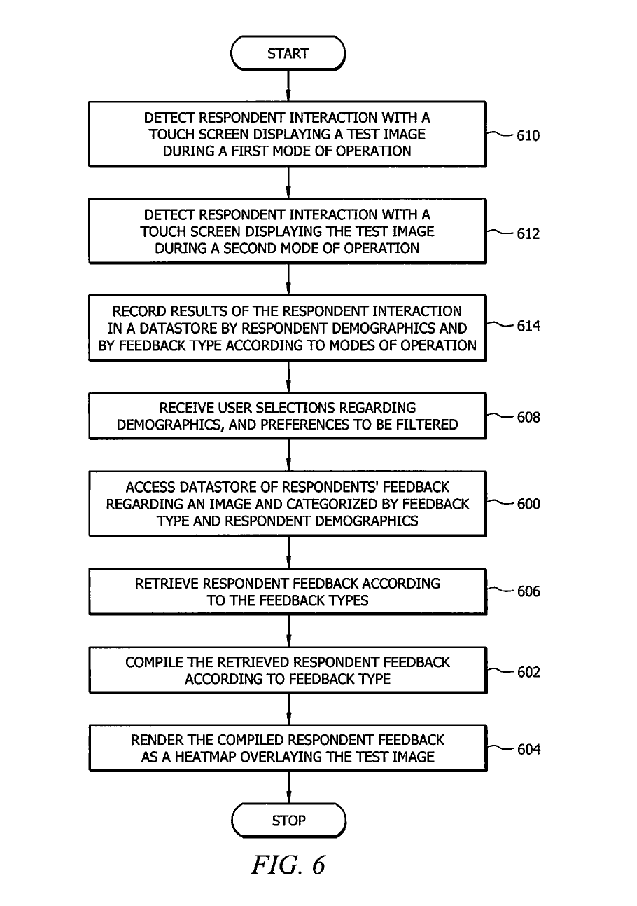

FIG. 6 illustrates a method of utilizing heat maps to represent respondent sentiments. At step 600, a computer processor may access a datastore recording respondent feedback corresponding to detected interaction by respondents, during first and second modes of operation, with a touch screen displaying a test image. The respondent feedback may be recorded in the datastore by feedback types according to the first and second modes of operation. In some embodiments, the first mode of operation is a positive feedback provision mode in which the respondent provides positive feedback for respondent selected regions of the test image by touching the touch screen to highlight portions of the test image utilizing highlight of a first hue. In these embodiments, the second mode of operation is a negative feedback provision mode in which the respondent provides negative feedback for respondent selected regions of the test image by touching the touch screen to highlight portions of the test image utilizing highlight of a second hue. In some embodiments, the respondent feedback is recorded in the datastore as highlight pixel data resulting from the respondent interaction. In additional or alternative embodiments, the respondent feedback is recorded in the datastore as respondent interaction objects that resulted in highlight of the test image during the first and second modes of operation.

At step 602, the respondent feedback may be compiled according to the feedback types, and graphically rendered, at step 604, as a feedback type specific heat map overlaying the test image. At step 606, the feedback may be retrieved from the datastore according to feedback type, and this retrieval may occur according to one or more user selections. For example, a user selection regarding the feedback type may be received at step 608, as may user selections regarding demographics of respondents. It should be understood that the respondent feedback may be recorded in the datastore by the respondent demographics, and that step 606 may include filtering the respondent feedback according to feedback type and/or demographics. Thus, step 602 may include compiling respondent feedback of the respondent demographics and/or feedback type selected by the user, and step 604 may include graphically rendering a respondent demographic specific heat map, and/or graphically rendering a heat map specific to the feedback type selected by the user.

In some embodiments, step 604 may include receiving user selections regarding whether to display the test image, and graphically rendering the respondent feedback as a feedback type specific heat map without the test image. In additional or alternative embodiments, step 604 may include simultaneously graphically rendering, side by side for comparison, two heat maps each specific to two different feedback types. In some embodiments, step 604 may include graphically rendering, together with the heat map, a prompt that was presented to the respondent for initiating the respondent interaction.

Certain embodiments include, at step 610, providing a display of the test image with respondent selectable controls for initiating the first and second modes of operation, and detecting the respondent interaction with the touch screen displaying the test image during the first mode of operation. These embodiments may additionally include detecting, at step 612, the respondent interaction with the touch screen displaying an image to be tested during a second mode of operation. These embodiments may further include recording results of the respondent interaction in the datastore, at step 614, by feedback type according to the first and second modes of operation.

The functional blocks and modules in FIGS. 2-5 may comprise processors, electronics devices, hardware devices, electronics components, logical circuits, memories, software codes, firmware codes, etc., or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

Although the present invention and its advantages have been described in detail, it should be understood that various changes, substitutions and alterations may be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. An apparatus utilizing heat maps to represent respondent sentiments, comprising:
a datastore recording respondent feedback corresponding to detected interaction by respondents, during first and second modes of operation, with a touch screen displaying a test image, wherein the respondent feedback is recorded in the datastore by feedback types according to the first and second modes of operation;
a feedback compilation engine compiling the respondent feedback according to the feedback types; and
a heat map rendering engine graphically rendering the respondent feedback as a feedback type specific heat map overlaying the test image.

2. The apparatus of claim 1, wherein the respondent feedback is further recorded in the datastore by respondent demographics, the apparatus further comprising:
a demographics filtering engine receiving user selections regarding the respondent demographics, and filtering the respondent feedback according to the user selections, thereby resulting in compiling respondent feedback of the respondent demographics selected by the user, and graphically rendering a respondent demographic specific heat map.

3. The apparatus of claim 1, further comprising:
a feedback type filtering engine receiving user selections regarding feedback type, and filtering the respondent feedback according to the user selections, thereby resulting in compiling respondent feedback of the feedback type selected by the user, and graphically rendering a heat map specific to the feedback type selected by the user.

4. The apparatus of claim 1, further comprising:
a background layer filtering engine receiving user selections regarding whether to display the test image, and graphically rendering the respondent feedback as a feedback type specific heat map without the test image.

5. The apparatus of claim 1, wherein said heat map rendering engine simultaneously graphically renders, side by side for comparison, two heat maps each specific to two different feedback types.

6. The apparatus of claim 1, wherein said heat map rendering engine graphically renders, together with the heat map, a prompt that was presented to the respondent for initiating the respondent interaction.

7. The apparatus of claim 1, wherein:
the first mode of operation is a positive feedback provision mode in which the respondent provides positive feedback for respondent selected regions of the test image by touching the touch screen to highlight portions of the test image utilizing highlight of a first hue; and
the second mode of operation is a negative feedback provision mode in which the respondent provides negative feedback for respondent selected regions of the test image by touching the touch screen to highlight portions of the test image utilizing highlight of a second hue.

8. The apparatus of claim 1, wherein the respondent interface provides a display of the test image with respondent selectable controls for initiating the first and second modes of operation, wherein the respondent interface detects the respondent interaction with the touch screen displaying the test image during the first and second modes of operation, and records results of the respondent interaction in the datastore by feedback type according to the first and second modes of operation.

9. The apparatus of claim 1, wherein the respondent feedback is recorded in the datastore as highlight pixel data resulting from the respondent interaction.

10. The apparatus of claim 1, wherein the respondent feedback is recorded in the datastore as respondent interaction objects that resulted in highlight of the test image during the first and second modes of operation.

11. A method of utilizing heat maps to represent respondent sentiments, comprising:
accessing, by a computer processor, a datastore recording respondent feedback corresponding to detected interaction by respondents, during first and second modes of operation, with a touch screen displaying a test image, wherein the respondent feedback is recorded in the datastore by feedback types according to the first and second modes of operation;
compiling the respondent feedback according to the feedback types; and
graphically rendering the respondent feedback as a feedback type specific heat map overlaying the test image.

12. The method of claim 11, wherein the respondent feedback is further recorded in the datastore by respondent demographics, the method further comprising:
receiving user selections regarding the respondent demographics; and
filtering the respondent feedback according to the user selections, thereby compiling respondent feedback of the respondent demographics selected by the user, and graphically rendering a respondent demographic specific heat map.

13. The method of claim 11, further comprising:
receiving user selections regarding feedback type; and
filtering the respondent feedback according to the user selections, thereby compiling respondent feedback of the feedback type selected by the user, and graphically rendering a heat map specific to the feedback type selected by the user.

14. The method of claim 11, further comprising:
receiving user selections regarding whether to display the test image; and
graphically rendering the respondent feedback as a feedback type specific heat map without the test image.

15. The method of claim 11, further comprising:
simultaneously graphically rendering, side by side for comparison, two heat maps each specific to two different feedback types.

16. The method of claim 11, further comprising:
graphically rendering, together with the heat map, a prompt that was presented to the respondent for initiating the respondent interaction.

17. The method of claim 11, wherein:
the first mode of operation is a positive feedback provision mode in which the respondent provides positive feedback for respondent selected regions of the test image by touching the touch screen to highlight portions of the test image utilizing highlight of a first hue; and
the second mode of operation is a negative feedback provision mode in which the respondent provides negative feedback for respondent selected regions of the test image by touching the touch screen to highlight portions of the test image utilizing highlight of a second hue.

18. The method of claim 11, further comprising:
providing a display of the test image with respondent selectable controls for initiating the first and second modes of operation;
detecting the respondent interaction with the touch screen displaying the test image during the first mode of operation;
detecting the respondent interaction with the touch screen displaying an image to be tested during a second mode of operation; and
recording results of the respondent interaction in the datastore by feedback type according to the first and second modes of operation.

19. The method of claim 11, wherein the respondent feedback is recorded in the datastore as highlight pixel data resulting from the respondent interaction.

20. The method of claim 11, wherein the respondent feedback is recorded in the datastore as respondent interaction objects that resulted in highlight of the test image during the first and second modes of operation.

21. A computer program product for utilizing heat maps to represent respondent sentiments, comprising:
a non-transitory computer-readable medium having program code recorded thereon, the program code including:
program code to access, by a computer processor, a datastore recording respondent feedback corresponding to detected interaction by respondents, during first and second modes of operation, with a touch screen displaying a test image, wherein the respondent feedback is recorded in the datastore by feedback types according to the first and second modes of operation;
program code to compile the respondent feedback according to the feedback types; and
program code to graphically render the respondent feedback as a feedback type specific heat map overlaying the test image.

22. The computer program product of claim 21, wherein the respondent feedback is further recorded in the datastore by respondent demographics, and the computer readable medium further comprises:
program code to receive user selections regarding the respondent demographics; and
program code to filter the respondent feedback according to the user selections, thereby compiling respondent feedback of the respondent demographics selected by the user, and graphically rendering a respondent demographic specific heat map.

23. The computer program product of claim 21, wherein the computer readable medium further comprises:
program code to receive user selections regarding feedback type; and
program code to filter the respondent feedback according to the user selections, thereby compiling respondent feedback of the feedback type selected by the user, and graphically rendering a heat map specific to the feedback type selected by the user.

24. The computer program product of claim 21, wherein the computer readable medium further comprises:
program code to receive user selections regarding whether to display the test image; and
program code to graphically render the respondent feedback as a feedback type specific heat map without the test image.

25. The computer program product of claim 21, wherein the computer readable medium further comprises:
program code to simultaneously graphically render, side by side for comparison, two heat maps each specific to two different feedback types.

26. The computer program product of claim 21, wherein the computer readable medium further comprises:
program code to graphically render, together with the heat map, a prompt that was presented to the respondent for initiating the respondent interaction.

27. The computer program product of claim 21, wherein:
the first mode of operation is a positive feedback provision mode in which the respondent provides positive feedback for respondent selected regions of the test image by touching the touch screen to highlight portions of the test image utilizing highlight of a first hue; and
the second mode of operation is a negative feedback provision mode in which the respondent provides negative feedback for respondent selected regions of the test image by touching the touch screen to highlight portions of the test image utilizing highlight of a second hue.

28. The computer program product of claim 21, wherein the computer readable medium further comprises:
program code to provide a display of the test image with respondent selectable controls for initiating the first and second modes of operation;
program code to detect the respondent interaction with the touch screen displaying the test image during the first mode of operation;
program code to detect the respondent interaction with the touch screen displaying an image to be tested during a second mode of operation; and
program code to record results of the respondent interaction in the datastore by feedback type according to the first and second modes of operation.

29. The computer program product of claim 21, wherein the respondent feedback is recorded in the datastore as highlight pixel data resulting from the respondent interaction.

30. The computer program product of claim 21, wherein the respondent feedback is recorded in the datastore as respondent interaction objects that resulted in highlight of the test image during the first and second modes of operation.
